(19) United States
(12) Patent Application Publication
(10) Pub. No.: US 2013/0092777 A1
(43) Pub. Date: Apr. 18, 2013

(54) GRINDING MILL

(71) Applicants: ABB Schweiz AG, Baden (CH); Outotec Oyj, Espoo (FI)

(72) Inventors: Jeff BELKE, Ardross West Australia (AU); Kjell WINTHER, Oslo (NO); Axel FUERST, Rufenach (CH); Iossif GRINBAUM, Turgi (CH); Bilal GERHARD, Niederrohdorf (CH)

(73) Assignees: Outotec Oyj, Espoo (FI); ABB Schweiz AG, Baden (CH)

(21) Appl. No.: 13/692,718

(22) Filed: Dec. 3, 2012

Related U.S. Application Data
(63) Continuation of application No. PCT/EP2011/059194, filed on Jun. 3, 2011.

(30) Foreign Application Priority Data
Jun. 2, 2010 (EP) 10164732.9

(51) Int. Cl. B02C 17/24

(52) U.S. Cl. CPC B02C 17/24
USPC 241/284

(57) ABSTRACT

A grinding mill includes a mill body defining a grinding cavity, the mill body supported at opposing sides by respective bearings, a motor, operable to drive the mill body and arranged adjacent to at least one bearing, and a torque transmitter. The torque transmitter has a diameter smaller than the diameter of the grinding cavity and larger than the diameter of the bearings.

RELATED APPLICATION(S)

This application claims priority as a continuation application under 35 U.S.C. §120 to PCT/EP2011/059194, which was filed as an International Application on Jun. 3, 2011 designating the U.S., and which claims priority to European Application 10164732.9 filed in Europe on Jun. 2, 2010. The entire contents of these applications are hereby incorporated by reference in their entireties.

### FIELD

The present disclosure relates to a grinding mill and, for example, to a grinding mill including a direct drive motor.

### BACKGROUND INFORMATION

Grinding mills can be used to break large pieces of mined material into smaller, manageable, pieces of material. Grinding mills can include geared mills and gearless mills. Gearless mills are also known as ring motor mills as they can be driven by a direct drive ring motor which is mounted around the outer shell of the mill body. Gearless mills do not involve components such as gears or pinions and as there are no mechanical parts relied upon to transmit the driving torque, the mechanical losses occurring, for example in the gearbox, can be eliminated.

An example of known ring motor mill 10 is shown in FIGS. 1 and 2. The mill body 12 is supported at opposing sides by bearings 16a, 16b. The rotor poles 18 of the ring motor 20 can be directly attached to a flange 22 on the outer shell 24 of the mill body 12. The stator 26 of the ring motor 20 is then mounted around the rotor poles 18, leaving an air gap 28 between the rotor 18 and the stator 26. A driving torque can be directly transmitted, by way of a magnetic field in the motor 20, to the mill body 12.

Ring motor cost can be dependent on the cross sectional diameter of the motor. In the case of a grinding mill ring motor, the cross sectional diameter of the motor can be determined by the cross sectional diameter of the outer shell of the mill body, around which the motor is installed. For a given mill power, as the mill cross sectional diameter increases, the ring motor cost also increases.

A factor of the power requirement for the mill is related to its cross-sectional diameter. This alone does not preclude standardization of the motors manufactured for use with mills. However, each mill can be custom built for a particular site or use. Therefore, for every mill, the motor is custom engineered to correspond to the size of the mill body it is to be used with. The constraint of the motor size being determined by the diameter of the mill body means that standardization of motors for this use is difficult.

DE 1937895 discloses a grinding mill with a mill body forming a grinding cavity and straight circular cylinder shaped engagement portions which are supported by bearings. Two direct drive motors are located on the engagement portions. In this design the size of the ring motor does not depend on the diameter of the mill body but on the diameter of the engagement portions.

Therefore, there is a need for a ring motor which is independent of the diameter of the mill cavity and the diameter of the engagement portions and which therefore may be standardized.

### SUMMARY

A grinding mill is disclosed, comprising: a mill body defining a grinding cavity, the mill body supported at opposing sides by respective bearings; a direct drive motor operable to drive the mill body and arranged adjacent at least one bearing; a torque transmitter adapted to transmit a torque from the direct drive motor to the mill body and having a diameter smaller than a diameter of the grinding cavity and larger than a diameter of the bearings.

A grinding mill family is disclosed, comprising: two grinding mills, each grinding mill including a mill body defining a grinding cavity; bearings respectively arranged at and supporting opposing sides of each mill body; a direct drive motor arranged as a ring motor operable to drive each mill body and arranged adjacent at least one bearing, wherein the grinding cavities of the two grinding mills have distinct outer diameters, wherein the two grinding mills have rotors of the direct drive motor with identical inner diameters and at least one of the two grinding mills has a torque transmitter which has a rotor-end circumference along which the torque transmitter is connected to a respective rotor of the ring motor and has a diameter that is larger than an outer diameter of an engagement portion between the torque transmitter and a respective bearing and smaller than an outer diameter of the grinding cavity of the at least one of the two grinding mills for compensating a radial gap between the rotor and the engagement portion.

### BRIEF DESCRIPTION OF THE DRAWINGS

Embodiments of the present disclosure will now be provided, by way of example only, and with reference to the following figures, in which:

FIG. 1 is a cross-sectional view from the front of a known ring motor grinding mill;

FIG. 2 is a cross-sectional view from the side of a known ring motor grinding mill;

FIG. 3 is cross-sectional view from the side of an exemplary embodiment of a grinding mill in accordance with the present disclosure;

FIG. 4 is a cross-sectional view from the side of an exemplary embodiment of a grinding mill in accordance with the present disclosure; and

FIG. 5 is a cross-sectional view from the side of a third exemplary embodiment of a grinding mill in accordance with the present disclosure.

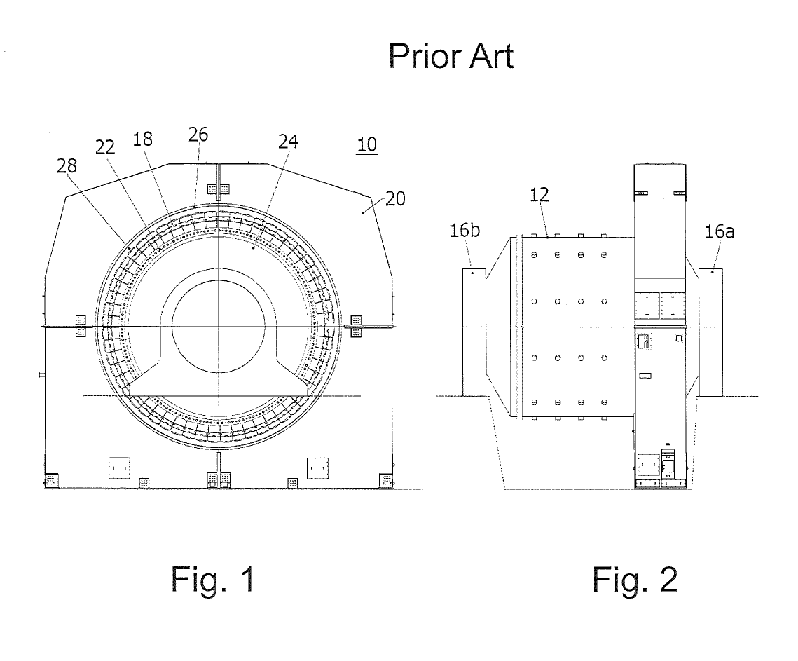

### DETAILED DESCRIPTION

According to an exemplary embodiment of the disclosure, there is provided a grinding mill defining a grinding cavity, the mill body supported at opposing sides by respective bearings, a direct drive motor, such as a ring motor, operable to drive the mill body and arranged adjacent at least one bearing and a torque transmitter that is rigidly connected to the mill body and adapted to transmit to the mill body the torque exerted by the direct drive motor. The diameter of the torque transmitter may be different from the diameter defined by the supporting bearings. If the diameter of the torque transmitter and the diameter of the supporting bearings coincide, the torque transmitter may be considered a part of an engagement portion of the mill body, or trunnion, that extends through the supporting bearings. Locating the direct drive motor adjacent to a supporting bearing of the mill body, rather than mounted on the outer shell of the grinding cavity, can avoid a requirement that the dimensions of the motor are determined by the dimensions of the grinding cavity outer shell.

In an exemplary embodiment of the disclosure, a rotor-end circumference of the torque transmitter along, which the torque transmitter is connected to the rotor of the ring motor, has a diameter that is larger than the outer diameter of the engagement portion and smaller than the outer diameter of the grinding cavity. The torque transmitter compensates a radial gap between the rotor and the engagement portion, wherein the mill-body-end of the torque transmitter where the torque transmitter is fixed to the mill body can be axially displaced with respect to the rotor, i.e. the torque transmitter is not necessarily exclusively radial. Thus, the diameter of the direct drive motor can be chosen independent of the diameter of the grinding cavity and independent of the diameter of the engagement portion which enables the use of standard direct drive motor sizes for various mill sizes.

In an exemplary embodiment of the disclosure, the mill-body-end of the torque transmitter can be fixed to the grinding cavity of the mill body. Thus, a more compact design can be achieved.

In an exemplary embodiment of the disclosure, the mill-body-end of the torque transmitter can be fixed to the engagement portion of the mill body. Thus, easier handling in the assembly of the direct drive motor can be achieved.

In an exemplary embodiment of the disclosure, the torque transmitter can be a separate element. Thus, easier transportation of the mill body can be achieved.

In an exemplary embodiment of the disclosure, the torque transmitter can be a torque tube with a continuous surface. Thus, there is a closed circumferential shear flow which can increase the transmittable torque.

In an exemplary embodiment of the disclosure, the torque transmitter can be rotationally symmetrical. Thus, the distribution of mass with respect to torque can be optimized and a larger torque is transmittable.

In an exemplary embodiment of the disclosure, the torque transmitter can be conical. Thus, the flux of forces can be straight and increases stiffness with respect to bending and torque can be achieved.

In an exemplary embodiment of the disclosure, the torque transmitter can include, instead of a continuous surface, a number of discrete elements distributed along a circumference of the torque transmitter. Thus, it is easier to manufacture the torque transmitter.

Throughout the following description, the same numbering has been used to identify the same component for each of the embodiments.

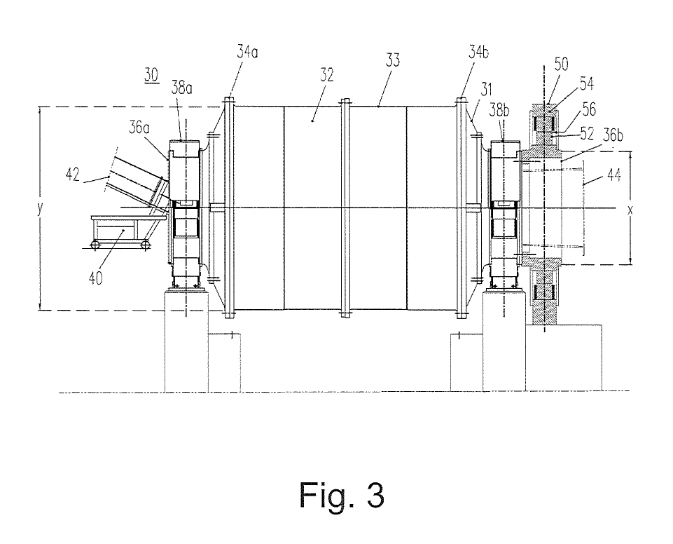

With reference to FIG. 3 there is shown a grinding mill 30 including a mill body 31 having a grinding cavity 32 provided at opposing sides 34a, 34b with engagement portions, in this case trunnions 36a, 36b, which are supported by bearings 38a, 38b respectively. Mill side 34a is provided with an input unit 40, for example, including a feed chute 42 into which material is fed into the grinding cavity 32 of the mill body 31 to be ground. Mill side 34b is provided with an output unit, for example, an output funnel 44, which extends from mill body side 34b through trunnion 36b beyond bearing 38b. The output funnel 44 transports the material being discharged out of the grinding cavity 32 of the mill body 31, through trunnion 36b to a trommel or screen. The grinding mill is provided with a motor 50, which in this embodiment can be a ring motor. A rotor 52 of a ring motor 50 is located on trunnion 36b with the bearing 38b located between the rotor 50 and the grinding cavity 32. A stator 54 of ring motor 50 is mounted around the rotor 52 with an air gap 56 left between the rotor 52 and stator 54. The ring motor 50 acts on the trunnion 36b which operates as a torque transmitter, or torque tube, to drive the mill body 31.

By arranging the motor 50 on the trunnion 36b, the dimensions of the motor 50 are not constrained by the cross sectional diameter y of the outer shell 33 of the grinding cavity 32 of the mill body 31 and instead are dependent upon the cross sectional diameter x of the trunnion 36b. The mounting of the motor 50 on the trunnion 36b will allow the motor 50 to be smaller and that can allow standardization which will lead to a reduction in manufacturing costs.

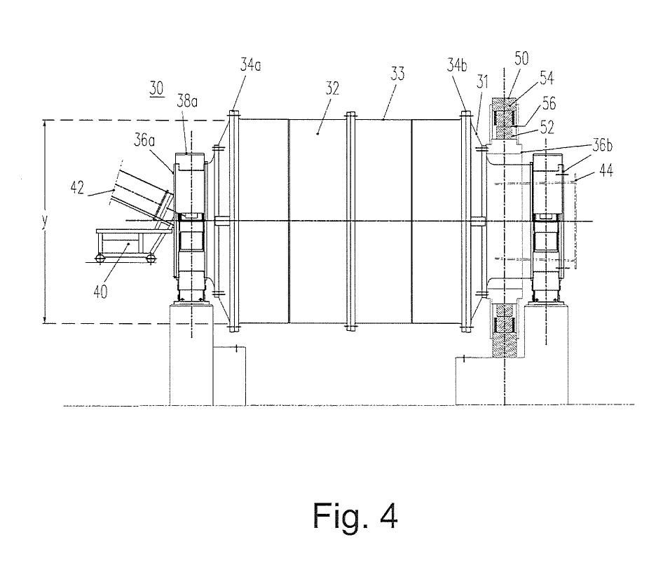

With reference to FIG. 4 there is shown an exemplary embodiment of a grinding mill 30 including a mill body 31 having a grinding cavity 32 provided at opposing sides 34a, 34b with engagement portions, in this case trunnions 36a, 36b, which are supported by bearings respectively. Mill side 34a is provided with an input unit 40, for example, including a feed chute 42 into which material is fed into the grinding cavity 32 of the mill body 31 to be ground. Mill side 34b is provided with an output unit, for example, an output funnel 44, which extends from mill body side 34b through trunnion 36b beyond bearing 38b. The output funnel 44 transports the material being discharged out of the grinding cavity 32 of the mill body 31 through trunnion 36b to a trommel or screen. The grinding mill is provided with a motor 50, which in this embodiment is a ring motor. A rotor 52 of a ring motor 50 is located on trunnion 36b between bearing 38b and grinding cavity 32 of the mill body 31. A stator 54 of ring motor 50 is mounted around the rotor 52 with an air gap 56 left between the rotor 52 and stator 54. Trunnion is fixed to the end face of the mill body along a circumference with a diameter halfway in-between the engagement portion and the cavity. The ring motor 50 acts on the trunnion 36b which operates as a torque transmitter, or torque tube to drive the mill body 32.

In the embodiments of FIG. 4, the motor size is not constrained by the outer shell diameter y of the grinding cavity 32 of the mill body 31 but instead, the diameter x of the feed and non-feed end trunnions.

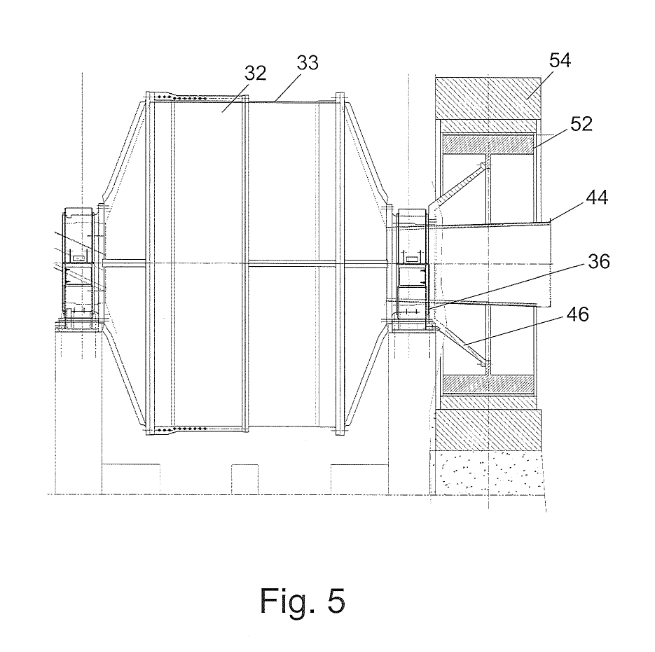

With reference to FIG. 5 there is shown a grinding mill 30 including a conical torque tube 46 which can compensate a radial gap between the rotor and the trunnion 36. It is fixed on one side to the trunnion and on the other side to a rotor 52 of the direct drive motor. In the embodiments of FIG. 5, the motor size is not constrained by the outer shell diameter y of the grinding cavity 32 of the mill body 31 nor the diameter x of the feed and non-feed end trunnions.

The grinding mill motor arrangement detailed above and accompanied, by way of example only, with the embodiments detailed in FIGS. 3, 4 and 5 will facilitate use of standardized ring motors and ring motor component in a similar manner as with known squirrel cage motors used within industry. Such standardization can increase the ability of grinding mill owners to hold common spares thus significantly reducing the cost of ring motor spare inventories.

Various modifications may be made to the embodiments hereinbefore described without departing from the scope of the disclosure. For example, it will be appreciated that whilst the engagement portion supported by the bearings and acted on by the motor is described with reference to the Figures as a trunnion, any suitable arrangement of apparatus which acts as a torque transmitter could be used. In addition whilst the above embodiments show arrangements having two bearings there may be more than one bearing provided at either side of the mill body.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

List of Reference Numerals

| | |
|---|---|
| 10 | ring motor mill |
| 12 | mill body |
| 16a, 16b | bearings |
| 18 | rotor poles |
| 20 | ring motor |
| 22 | flange |
| 24 | outer shell |
| 26 | stator |
| 28 | air gap |
| 30 | grinding mill |
| 31 | mill body |
| 32 | grinding cavity |
| 33 | outer shell |
| 34a, 34b | opposing sides |
| 36a, 36b | trunnions |
| 38a, 38b | bearings |
| 40 | input unit |
| 42 | feed chute |
| 44 | funnel |
| 46 | torque tube |
| 50 | motor |
| 52 | rotor |
| 54 | stator |
| 56 | air gap |

What is claimed is:

1. A grinding mill, comprising:
a mill body defining a grinding cavity, the mill body supported at opposing sides by respective bearings;
a direct drive motor operable to drive the mill body and arranged adjacent at least one bearing;
a torque transmitter adapted to transmit a torque from the direct drive motor to the mill body and having a diameter smaller than a diameter of the grinding cavity and larger than a diameter of the at least one bearing.

2. The grinding mill as claimed in claim 1, comprising:
a rotor-end circumference of the torque transmitter along which the torque transmitter is connected to a rotor of the direct drive motor, the rotor-end circumference having a diameter that is larger than an outer diameter of an engagement portion of the at least one bearing and smaller than an outer diameter of the grinding cavity and wherein the torque transmitter compensates a radial gap between the rotor and the engagement portion.

3. The grinding mill as claimed in claim 1, wherein a mill-body-end of the torque transmitter is fixed to the grinding cavity of the mill body.

4. The grinding mill as claimed in claim 2, wherein a mill-body-end of the torque transmitter is fixed to the engagement portion of the mill body.

5. The grinding mill as claimed in claim 1, wherein the torque transmitter is a separate element.

6. The grinding mill as claimed in claim 1, wherein the torque transmitter is a torque tube.

7. The grinding mill as claimed in claim 6, wherein the torque transmitter is rotationally symmetrical.

8. A grinding mill as claimed in claim 7, wherein the torque transmitter is conical.

9. A grinding mill as claimed in claim 1, wherein the torque transmitter comprises discrete elements.

10. The grinding mill as claimed in claim 2, wherein a mill-body-end of the torque transmitter is fixed to the grinding cavity of the mill body.

11. The grinding mill as claimed in claim 2, wherein the torque transmitter is a separate element.

12. The grinding mill as claimed in claim 3, wherein the torque transmitter is a separate element.

13. The grinding mill as claimed in claim 4, wherein the torque transmitter is a separate element.

14. The grinding mill as claimed in claim 2, wherein the torque transmitter is a torque tube.

15. The grinding mill as claimed in claim 3, wherein the torque transmitter is a torque tube.

16. The grinding mill as claimed in claim 4, wherein the torque transmitter is a torque tube.

17. The grinding mill as claimed in claim 5, wherein the torque transmitter is a torque tube.

18. A grinding mill as claimed in claim 2, wherein the torque transmitter comprises discrete elements.

19. A grinding mill as claimed in claim 3, wherein the torque transmitter comprises discrete elements.

20. A grinding mill family, comprising:
two grinding mills, each grinding mill including a mill body defining a grinding cavity; and arranged to be supported at opposing sides by bearings;
a direct drive motor arranged as a ring motor operable to drive the mill body and arranged adjacent at least one bearing,
wherein the grinding cavities of the two grinding mills have distinct outer diameters, wherein the two grinding mills have rotors of the direct drive motor with identical inner diameters and at least one of the two grinding mills has a torque transmitter which has a rotor-end circumference along which the torque transmitter is connected to a rotor of the respective direct drive motor and the rotor-end circumference having a diameter that is larger than an outer diameter of an engagement portion of a bearing arranged adjacent to the direct drive motor and smaller than an outer diameter of the grinding cavity of the at least one of the two grinding mills, wherein the torque transmitter is adapted to compensate a radial gap between the rotor and the engagement portion.
